(19) United States
(12) Patent Application Publication
(10) Pub. No.: US 2009/0058308 A1
(43) Pub. Date: Mar. 5, 2009

(54) APPARATUS AND METHOD FOR LIGHTING DIELECTRIC BARRIER DISCHARGE LAMP

(75) Inventors: Toshiaki Kurachi, Kyoto (JP); Satoshi Kominami, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/159,899

(22) PCT Filed: Mar. 20, 2007
(86) PCT No.: PCT/JP2007/055691

§ 371 Date: Jul. 2, 2008

(30) Foreign Application Priority Data
May 9, 2006 (JP) 2006-129947

(51) Int. Cl. H05B 41/00

(52) U.S. Cl. 315/160

(57) ABSTRACT

A pair of internal electrodes are disposed at both ends of a lamp. A first voltage including a positive DC voltage superimposed on a substantial rectangular waveform voltage is applied to one of the internal electrodes. A second voltage including a negative DC voltage superimposed on the substantial rectangular waveform voltage is applied to the other internal electrode. The dark portion occurring substantially at the center in the longitudinal direction of the lamp becomes invisible, so that the brightness distribution is improved.

### TECHNICAL FIELD

The present invention relates to an apparatus and a method of lighting a dielectric barrier discharge lamp having an external electrode and internal electrodes placed at both ends of the lamp.

### BACKGROUND ART

In recent years, with the development of liquid crystal technology, liquid crystal displays have been commonly used as information display apparatuses such as televisions and monitors. A liquid crystal display has a structure in which a light source apparatus (hereinafter, referred to as a “backlight”) is placed on the back of liquid crystal panel and light from the backlight is transmitted through the liquid crystal panel to achieve screen display. As a main light source for the backlight, a plurality of elongated cold cathode fluorescent lamps are often used.

Meanwhile, a further improvement in the performance of the light source for a backlight is expected, and accordingly, external electrode type fluorescent lamps have been actively researched and developed. A dielectric barrier discharge lamp does not contain mercury inside the lamp and uses rare gas light emission and thus has features that the lamp is environmentally friendly and has excellent recycling performance. Furthermore, since the dielectric barrier discharge lamp does not contain mercury, the dielectric barrier discharge lamp has a feature in that there is almost no temporal change in luminous flux occurring before mercury inside the lamp is heated and sufficiently vaporized, which is encountered in conventional cold cathode fluorescent lamps, resulting in instant turn-on of light of the dielectric barrier discharge lamp.

One of a preferred exemplary configurations of the dielectric barrier discharge lamp is shown in FIGS. 12A and 12B that includes a pair of internal electrodes 2a and 2b mounted inside and at both ends of a lamp 1, and an external electrode 3 placed along a longitudinal direction of the lamp (refer to Patent Document 1). A lighting apparatus for such a lamp alternately connects the internal electrode 2a or 2b to a power supply E by a selection switch SW. That is, when the internal electrode 2a is connected to the power supply E by the selection switch SW, a discharge occurs between the internal electrode 2a and the external electrode 3, emitting light (the state in FIG. 12A). On the other hand, when the internal electrode 2b is connected to the power supply E by the selection switch SW, a discharge occurs between the internal electrode 2b and the external electrode 3, emitting light (the state in FIG. 11B). Thus, by switching the connection of the selection switch SW at a predetermined frequency, the side of the internal electrode 2a and the side of the internal electrode 2b are alternately illuminated and thus averaged light emission as a whole can be obtained.

Patent Document 1: JP 2004-127540 A (see FIG. 1)

### DISCLOSURE OF THE INVENTION

### Problems to be Solved by the Invention

However, inventors of the present invention has been found as a result of an experiment which is conducted by the inventors, that light emission efficiency decreases by as much as 10% to 20% at maximum when the lamp 1 in the above-described configuration in FIGS. 12A and 12B is lighted, as compared with the case of lighting the lamp 1 with the internal electrode 2a and the internal electrode 2b being always connected to the power supply E.

On the other hand, in the case of lighting the lamp 1 with the internal electrode 2a and the internal electrode 2b always connected to the power supply E, almost no light is emitted at substantially the midpoint between the internal electrodes 2a and 2b in the longitudinal direction of the lamp 1. The reason for this is that an electric field applied from the internal electrode 2a and an electric field applied from the internal electrode 2b collide with each other and the electric field becomes substantially zero at a central portion of the lamp 1. Thus, at substantially the central portion of the lamp 1, a region that is remarkably darker than the periphery thereof appears, resulting in drawbacks in that not only the luminance uniformity ratio is significantly degraded but also the visibility of the dark portion is very high.

An advantage of the configuration having the internal electrodes 2a and 2b provided at both ends instead of at one end of the lamp 1 is that efficiency is higher than the case of provision of an internal electrode at only one end. Regardless of this fact, when in such a configuration alternate driving of the internal electrodes 2a and 2b such as that shown in FIGS. 12A and 12B is performed to enhance the uniformity of light emission, light emission efficiency decreases. Namely, it is very difficult to achieve both high efficiency and high uniformity ratio.

The present invention is made to solve the above- described problems and an object of the present invention is to provide a lighting method and a lighting apparatus for a dielectric barrier discharge lamp, capable of preventing a distinct dark portion from appearing at a substantially central portion in a longitudinal direction of the lamp while maintaining the light emission efficiency of the lamp, resulting in improved uniformity ratio of light emission.

### Means for Solving the Problems

A lighting apparatus for a dielectric barrier discharge lamp according to the invention is an apparatus for lighting a dielectric barrier discharge lamp which includes a transparent container filled with a discharge medium containing a rare gas, a pair of internal electrodes at both ends of the transparent container, and an external electrode placed along a longitudinal direction of the translucent container. The lighting apparatus includes: a first drive circuit for generating a first substantial rectangular wave voltage including a predetermined substantial rectangular wave voltage on which a positive direct-current voltage is superimposed; and a second drive circuit for generating a second substantial rectangular wave voltage including a predetermined substantial rectangular wave voltage on which a negative direct-current voltage is superimposed. The first drive circuit is connected to one of the pair of internal electrodes and the external electrode so as to apply the first substantial rectangular wave voltage thereto. The second drive circuit is connected to the other of the pair of internal electrodes and the external electrode so as to apply the second substantial rectangular wave voltage thereto.

Preferably, the first substantial rectangular wave voltage and the second substantial rectangular wave voltage may have substantially the same phase. The first drive circuit and the second drive circuit may preferably be inverter circuits which are driven by a single drive signal circuit.

The first drive circuit may have a first step-up transformer which has a first primary winding, a second primary winding, and a first secondary winding. The second drive circuit may have a second step-up transformer, which has a third primary winding, a fourth primary winding, and a second secondary winding. The number of turns of the first primary winding may be substantially equal to a number of turns of the fourth primary winding, and a number of turns of the second primary winding may be substantially equal to a number of turns of the third primary winding. A difference in number of turns between the first primary winding and the second primary winding may be between one turn and two turns.

An impedance element may be connected in series to at least a primary winding with a smallest number of turns among the first to fourth primary windings. The impedance element may be an inductor having an inductance of between 1 μH and 5 μH.

The positive direct-current voltage and the negative direct-current voltage may have a substantially equal absolute value. A relationship between an amplitude Va of the predetermined substantial rectangular wave voltage and an absolute value Vb of the positive and negative direct-current voltages may satisfy the following equation,

0.025 Va≦Vb≦0.10 Va.

A lighting method for a dielectric barrier discharge lamp is a method of lighting a dielectric barrier discharge lamp which includes a transparent container filled with a discharge medium containing a rare gas, a pair of internal electrodes at both ends of the transparent container, and an external electrode placed along a longitudinal direction of the translucent container. The method includes: applying a first substantial rectangular wave voltage to one of the internal electrodes, the first substantial rectangular wave voltage including a predetermined substantial rectangular wave voltage on which a positive direct-current voltage is superimposed; and applying a second substantial rectangular wave voltage to the other of the internal electrodes, the second substantial rectangular wave voltage including a predetermined substantial rectangular wave voltage on which a negative direct-current voltage is superimposed.

### Effects of the Invention

The present invention can significantly reduce the visibility of a dark portion formed at a central portion of the lamp without impairing high light emission efficiency which is a feature of a dielectric barrier discharge lamp having internal electrodes at both ends of the lamp. Accordingly, both of high efficiency and high uniformity ratio of the lamp can be achieved.

### BRIEF DESCRIPTION OF DRAWINGS

FIG. 1 is a schematic diagram showing a lighting method for a dielectric barrier discharge lamp according to a first embodiment of the present invention.

FIGS. 2A and 2B are timing charts for explaining the operations of power supplies of a lighting apparatus for the dielectric barrier discharge lamp according to the first embodiment of the present invention.

FIG. 3 is a diagram showing a luminance distribution of the lamp by the lighting apparatus for the dielectric barrier discharge lamp according to the first embodiment of the present invention.

FIG. 4 is a diagram showing a configuration of a lighting apparatus for a dielectric barrier discharge lamp according to a second embodiment of the present invention.

FIGS. 5A and 5B are schematic diagrams showing output voltage waveforms of the lighting apparatus for the dielectric barrier discharge lamp according to the second embodiment of the present invention.

FIG. 6 is a diagram showing an output voltage waveform of the lighting apparatus for the dielectric barrier discharge lamp according to the second embodiment of the present invention.

FIG. 7A is a diagram showing lighting states by a lighting apparatus for a dielectric barrier discharge lamp using a conventional lighting method (without a diffuser), and FIG. 7B is a diagram showing lighting states by a lighting apparatus of a dielectric barrier discharge lamp using a conventional lighting method (with a diffuser).

FIG. 8A is a diagram showing a lighting state by the lighting apparatus for the dielectric barrier discharge lamp according to the second embodiment of the present invention, and FIG. 8B is a diagram showing a lighting state by a conventional lighting apparatus of a dielectric barrier discharge lamp.

FIG. 9 is a diagram showing a comparison of luminance distributions between the lighting apparatus for the dielectric barrier discharge lamp according to the second embodiment of the present invention and the conventional lighting apparatus for the dielectric barrier discharge lamp.

FIG. 10 is a diagram showing a configuration of a lighting apparatus for a dielectric barrier discharge lamp according to a third embodiment of the present invention.

FIG. 11A is a diagram showing the voltage and current waveforms of a power supply section before inserting an impedance element, and FIG. 11B is a diagram showing the voltage and current waveforms of the power supply section after inserting an impedance element, in the lighting apparatus for the dielectric barrier discharge lamp according to the third embodiment of the present invention.

FIGS. 12A and 12B are diagrams showing a configuration of a conventional lighting apparatus for a discharge lamp.

### REFERENCE SINGS

1: LAMP

2a and 2b: INTERNAL ELECTRODE

3: EXTERNAL ELECTRODE

4: DRIVE SIGNAL CIRCUIT

5: HEAT SHRINKABLE TUBE

E0, E1, E2: POWER SUPPLY

T1, T2: STEP-UP TRANSFORMER

L111, L112, L211, L212: PRIMARY WINDING

L12, L22: SECONDARY WINDING

L1, L2: SERIES INDUCTOR

S11, S12, S21, S22: SWITCHING ELEMENT

SW: SELECTION SWITCH

### BEST MODE FOR CARRYING OUT THE INVENTION

Embodiments of the present invention will be described below with reference to the drawings.

### First Embodiment

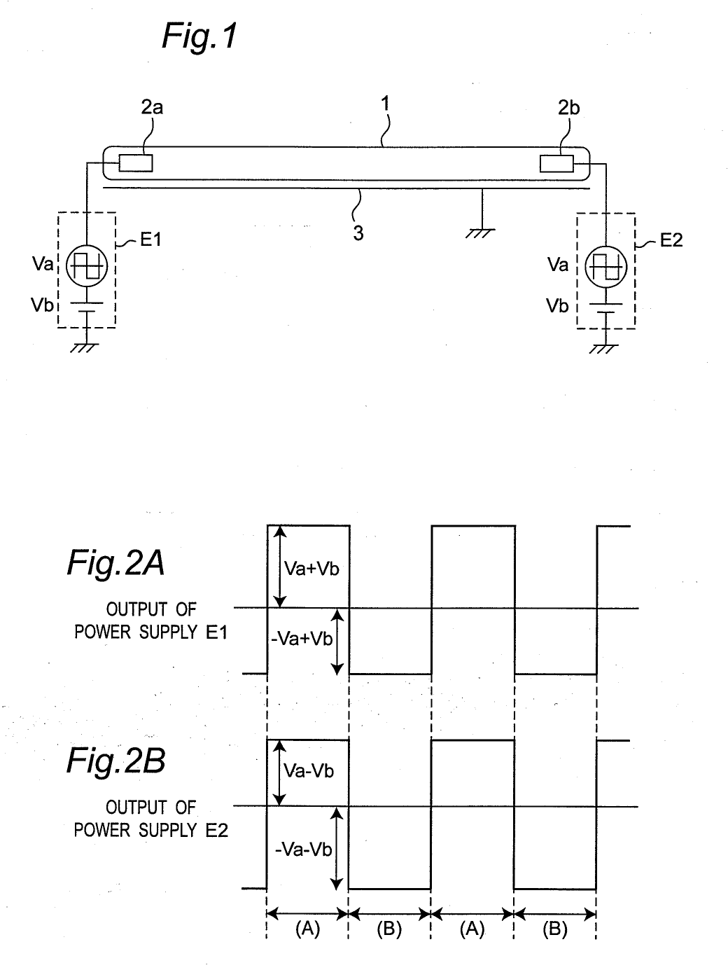

FIG. 1 is a diagram schematically showing a lighting method and a lighting apparatus of a dielectric barrier discharge lamp according to a first embodiment of the present invention.

In FIG. 1, a lamp 1 is a dielectric barrier discharge lamp having a pair of internal electrodes 2a and 2b disposed at both ends thereof and further having an external electrode 3 disposed along an axis in a longitudinal direction of the lamp 1. The lamp 1 is made of transparent material, such as soda glass or borosilicate glass, and filled with a discharge gas mainly composed of xenon gas therein. Furthermore, a phosphor coating is formed on an inner surface of the lamp 1. Note that the dimensions of the lamp 1 of the first embodiment are as follows: the outside diameter is φ 3.0 mm and the length is 700 mm.

Each of the internal electrode 2a and the external electrode 3 is connected to a power supply E1 and each of the internal electrode 2b and the external electrode 3 is connected to a power supply E2. Note that the external electrode 3 is preferably held at ground potential.

The power supply E1 produces a voltage waveform generated by superimposing a direct-current voltage (Vb) on an alternating voltage of a substantial rectangular wave (amplitude Va). On the other hand, the power supply E2 produces a voltage waveform generated by superimposing a direct-current voltage (−Vb) on an alternating voltage of a substantial rectangular wave (amplitude Va). The power supplies E1 and E2 operate in phase and at the same frequency, as shown in timing charts shown in FIG. 2.

The reason that a substantial rectangular wave voltage is preferable is that applying a current flowing through the lamp 1 in a pulse form causes a non-operating period to be long so that light emission efficiency can be increased. Note that in the case of the dielectric barrier discharge lamp, a capacitor is composed of a plurality of electrodes. Therefore, the impedance of the lamp 1 is capacitive. Hence, a waveform of a current flowing through the lamp 1 is a waveform of a differentiated voltage and thus is formed in a pulse form in principle.

A lighting operation of the dielectric barrier discharge lamp configured in the above-described manner will be described below.

When high voltages of a substantial rectangular wave generated by the power supplies E1 and E2 are applied between the internal electrodes 2a and 2b and the external electrode 3, a charge current of a pulse form flows through a capacitance composed of the internal electrodes 2a and 2b, the external electrode 3, the glass material of the lamp 1, and so on. That is, discharge electrons are supplied to the lamp 1 from the internal electrodes 2a and 2b. The discharge electrons are accelerated by the high voltages applied to the internal electrodes 2a and 2b and sequentially trapped on an inner wall of the lamp 1 while drifting from a both-end of the lamp 1 toward a central portion of the lamp 1. The accelerated electrons collide with the discharge gas filled in the lamp 1 and excite the gas so that excimer light emission by the xenon gas is generated and a diffused positive column is produced.

The electric field inside the lamp 1 due to the above-described high voltages is highest near the internal electrodes 2a and 2b and decreases toward the center in the longitudinal direction of the lamp 1. Then, an electric field generated from the internal electrode 2a side collides with an electric field generated from the internal electrode 2b side, so that the electric field strength becomes substantially zero at a specific region. When the electric field strength becomes zero, the discharge electrons are no longer accelerated and accordingly excitation and light emission of the discharge gas hardly occur, forming a dark portion in the specific region. Here, the slope of the electric field strength is determined mostly by the distribution of the capacitance held by the lamp 1 and does not depend on voltages to be applied to the internal electrodes 2a and 2b.

As shown in FIG. 2, the relationship of voltages at the internal electrodes 2a and 2b has the following two types of relationship depending on the time, and a location where the electric field strength becomes zero in each type can be considered as follows:

(1) Timing A

Potential of the internal electrode 2a; Va+Vb

Potential of the internal electrode 2b; Va−Vb

Location of a dark portion; point at which the distance between the internal electrodes 2a and 2b is divided internally in the ratio (Va+Vb):(Va−Vb)

(2) Timing B

Potential of the internal electrode 2a; −Va+Vb

Potential of the internal electrode 2b; −Va−Vb

Location of a dark portion; point at which the distance between the internal electrodes 2a and 2b is divided internally in the ratio (Va−Vb): (Va+Vb).

That is, during a time zone in which the voltages applied to the internal electrodes 2a and 2b are positive, a dark portion is formed somewhat nearer the internal electrode 2b, while during a time zone in which the voltages applied to the internal electrodes 2a and 2b are negative, a dark portion is formed somewhat nearer the internal electrode 2a. Thus, the dark portion moves back and forth between the above-described two points at the same frequency as the frequency of alternating voltage component generated by the power supplies E1 and E2. Hence, a light output in a region where the dark portion moves is an output averaged with a light output obtained when light is emitted and a light output obtained when the dark portion is present.

Next, a relationship between the values of the amplitude Va of the substantial rectangular wave alternating voltage and the direct-current offset voltage Vb will be mentioned.

The magnitude relationship between Va and Vb needs to be always such that Va>Vb. If Va<Vb, the potential of the internal electrode 2a is always positive and the potential of the internal electrode 2b is always negative. In this case, substantially independently of the external electrode 3, the discharge electrons move directly from the internal electrode 2a to the internal electrode 2b. This discharge form is similar to that of normal fluorescent lamps, and so on, and thus the discharge can be no longer called a dielectric barrier discharge. At this time, the discharge gas inside the lamp stops producing excimer so that discharge efficiency extremely decreases.

On the other hand, to maximize the light emission efficiency of the lamp 1, voltages that can be applied to the internal electrodes 2a and 2b are limited to a specific range by the design of the lamp 1. The reasons are as follows. First, when the voltages are too high, a shrunk positive column results, and accordingly, not only efficiency extremely decreases but also flicker occurs due to snaking of a contracted portion. Secondary, when the voltages are too low, since the electric field strength inside the lamp 1 is low, excimer production efficiency decreases, and accordingly, not only the light emission efficiency of the lamp 1 decreases but also discharge does not reach the vicinity of the central portion of the lamp 1.

For the above-described reasons, to prevent the light emission efficiency of the lamp 1 from being impaired, it is preferable to set the voltages to be applied to the internal electrodes 2a and 2b as follows. Specifically, it is preferable to apply not so high direct-current offset voltage Vb and to keep the voltages at a sufficiently low value as compared with the amplitude Va of a substantial rectangular wave alternating component. Furthermore, when the moving range of the dark portion is set to be too wide, the dark portion cannot follow well and thus a case in which the dark portion may move only once every several cycles occurs and flicker of the lamp 1 is confirmed visually.

When the direct-current offset voltage Vb is very low and thus the moving range of the dark portion is too narrow, the visibility of the dark portion at the central portion of the lamp 1 gradually increases and accordingly the effect of an improvement in uniformity ratio is deteriorated.

As a result of studying a preferred range of the direct-current offset voltage Vb, taking into account the above-described phenomena, it is preferred that the value of Vb be set so as to satisfy the following equation:

0.025 Va≦Vb≦0.10 Va.

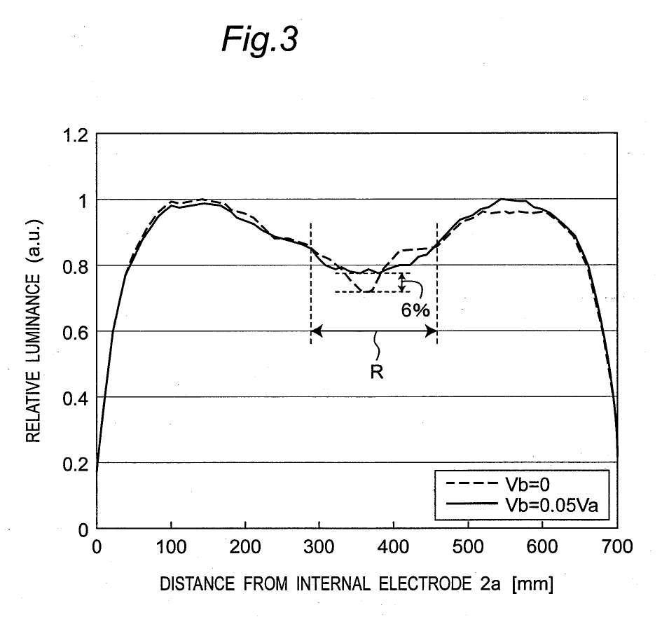

FIG. 3 shows an example of the luminance distribution in the longitudinal direction of the lamp 1 with the direct-current offset voltage Vb added. Note that the measurement results are shown which are measured with an external power supply (manufactured by Haiden Laboratory Inc., SBP-5K-HF-1) that can produce an ideal rectangular wave. As a comparative example, a luminance distribution with Vb=0 (the case in which the internal electrodes 2a and 2b are kept at equal potential) is also depicted. In each measurement, the same value is used for the rectangular wave alternating voltage Va, and the same lamp 1 having a xenon gas of 120 Torr filled therein is used. In the measurement of a luminance distribution, the external electrode is composed of one aluminum plate which also serves as a light reflector plate, sixteen lamps 1 are arranged on the external electrode, and a diffuser is further placed on the external electrode, and then the measurement is performed along an axis in a longitudinal direction of the lamps 1.

As can be seen from FIG. 3, in the case of Vb=0 by a conventional lighting method, i.e., the case in which the internal electrodes 2a and 2b are kept at equal potential, the luminance of central portion in the longitudinal direction of the lamps 1 suddenly drops. In visual sense of human eyes, viewing of a dark portion is recognized by contrast with the luminance of the periphery of the dark portion. Thus, the dark portion is very distinctly recognized when there is a great difference in brightness between the dark portion and the periphery thereof. In other words, when the differential value (slope) of a graph of the luminance distribution is large, a difference in brightness between the dark portion and the periphery thereof is easily recognized. In this case, the dark portion is recognized more distinctly than actual luminance non-uniformity and thus a user feels unpleasant. Note that since the measurements are performed with a diffuser being placed, it becomes quite difficult to see dark portions in the vicinity of the central portions of the lamps 1 due to diffused light. However, the luminance suddenly drops at the dark portions.

On the other hand, in the case of Vb=0.05 Va by the lighting method of the present invention, although dark portions are similarly formed in the vicinity of the central portions in the longitudinal direction of the lamps 1, the luminance uniformity ratio (the value obtained by dividing minimum luminance by maximum luminance) is improved by about 6%. Although the value 6% itself is small, the differential value (slope) of the luminance distribution near the dark portions becomes small and thus the dark portions become difficult to be recognized, resulting in a far better visual impression than the degree of a numerical improvement in luminance distribution. Note that in FIG. 3 a range R is the moving range of the dark portions and in this range the luminance is substantially uniform.

The light emission efficiency of the lamps 1 is determined by calculation. The light emission efficiency of the lamps 1 for the case of Vb=0.05 Va decreases by as little as only 2%, as compared with the case of Vb=0. This is a difference in level which can be considered to be calculation error, and it is surprisingly high efficiency as compared with the decrease in efficiency (−10 to −20%) for the case in which the internal electrodes 2a and 2b are driven by alternately applying a voltage thereto, as in the conventional art.

As described above, a combined voltage of a positive direct-current offset voltage Vb and a rectangular wave alternating voltage Va is applied to the internal electrode 2a and a combined voltage of a negative direct-current offset voltage Vb and a rectangular wave alternating voltage Va is applied to the internal electrode 2b. Hence excellent effects are provided, in which hardly impairing the light emission efficiency of the lamp 1, a luminance distribution can be improved and the visibility of a dark portion formed near the central portion in the longitudinal direction of the lamp 1 can be reduced.

In the present invention, the effects can be obtained with the rectangular wave alternating voltage Va of any value. A luminance distribution can be further brought close to a uniform value by increasing the rectangular wave alternating voltage Va. However, when the rectangular wave alternating voltage Va is increased too high, shrunk positive columns result near the internal electrodes 2a and 2b, and the light emission efficiency of the lamp 1 decreases. Thus, it is necessary for the amplitude of the rectangular wave alternating voltage Va to be resolutely kept within a range where shrunk positive columns are not produced in a maximum voltage amplitude (Va+Vb) to be applied to the internal electrodes 2a and 2b.

In the first embodiment, the absolute values of direct-current offset voltages of the power supply E1 and the power supply E2 are made equal to each other. However, even when the absolute values of both voltages are different, similar effects can be obtained. However, this arrangement is not appropriate when considering application to displays, since light emission luminance at both ends of the lamp 1 may often become asymmetrical by the arrangement.

### Second Embodiment

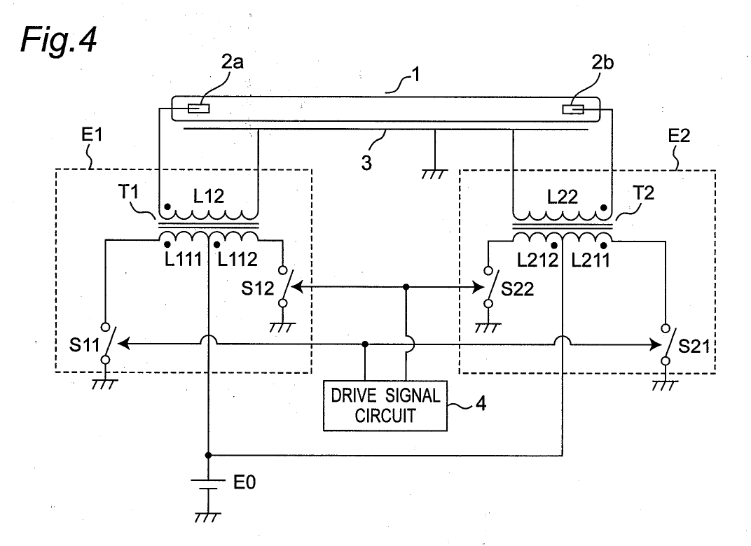

FIG. 4 is a diagram showing a configuration of a lighting apparatus for a dielectric barrier discharge lamp according to a second embodiment of the present invention. Note that the configuration in the present embodiment is such that the power supplies E1 and E2 in the first embodiment are configured by push-pull inverters and the inverters are connected to a direct-current power supply E0.

The operation of the lighting apparatus for a dielectric barrier discharge lamp based on the above-described configuration will be described with reference to FIG. 4.

The inverter power supplies E1 and E2 convert direct-current power from the direct-current power supply E0 to alternating power of a substantial rectangular wave voltage in the manner described below, according to switching operation of switching elements.

First, a drive signal circuit 4 generates two types of drive signals for driving four switching elements S11, S12, S21, and S22. One of the drive signals is an on/off signal for the switching elements S11 and S21 and the other dive signal is an on/off signal for the switching elements S12 and S22. The above-described two drive signals alternately generate an on signal. Specifically, when one generates an on signal, the other generates an off signal. Therefore, the operating states of the circuit have the following two states.

State A:

Switching elements S11 and S21: Off

Switching elements S12 and S22: On

At this time, a current flows through each of primary windings L112 and L212 of step-up transformers T1 and T2 in the power supplies E1 and E2, and as a result, such high voltages that apply positive voltages to the internal electrodes 2a and 2b of the lamp 1 are respectively generated at secondary windings L12 and L22 of the step-up transformers T1 and T2.

State B:

Switching elements S11 and S21: On

Switching elements S12 and S22: Off

At this time, a current flows through each of primary windings L111 and L211 of the step-up transformers T1 and T2 in the power supplies E1 and E2, and as a result, such high voltages that apply negative voltages to the internal electrodes 2a and 2b of the lamp 1 are respectively generated at the secondary windings L12 and L22 of the step-up transformers T1 and T2.

By alternately repeating the above-described two states, in the lamp 1, alternating high voltages are applied between the internal electrodes 2a and 2b and an external electrode 3, resulting in discharge plasma produced inside the lamp 1. Note that according to the above-described configuration the power supplies E1 and E2 can supply substantial rectangular waves in phase and at the same frequency to the lamp 1.

Alternating voltages (voltages respectively generated at the secondary windings L12 and L22 of the step-up transformers T1 and T2) applied to the lamp 1 are of a substantial rectangular wave, which is the same as in the above-described first embodiment. When the coupling coefficient of each winding of the step-up transformers T1 and T2 is small, the waveform is significantly distorted due to leakage inductance. Therefore, it is preferably configured such that the coupling coefficient of each transformer is 0.995 or greater.

Each winding of each of the step-up transformers T1 and T2 is configured by the following number of turns.

Primary windings L111 and L212: Number of turns N11

Primary windings L112 and L211: Number of turns N12

Secondary windings L12 and L22: Number of turns N2

When a current is flowing through each primary winding of the step-up transformers T1 and T2, voltages to be generated on the secondary windings (voltages to be applied to the internal electrodes 2a and 2b) are defined by the turns ratio of the windings, i.e., as follows:

in State A:

Voltage to be applied to the internal electrode 2a:

E0×N2/N12

Voltage to be applied to the internal electrode 2b:

E0×N2/N11

in State B:

Voltage to be applied to the internal electrode 2a:

−E0×N2/N11

Voltage to be applied to the internal electrode 2b:

−E0×N2/N12.

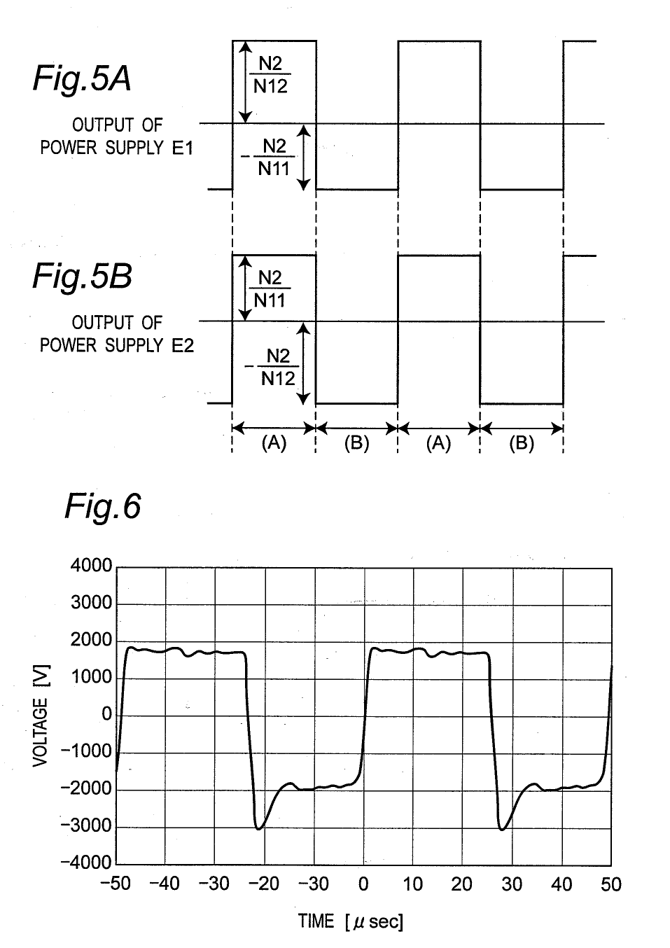

When it is configured such that N11>N12, schematic waveforms of voltages to be respectively applied to the internal electrodes 2a and 2b are as shown in FIG. 5, in which a direct-current offset voltage is superimposed on each waveform of a substantial rectangular wave voltage. An amplitude Va of the substantial rectangular wave voltage and the direct-current offset voltage Vb at this time are as follows:

Va=E0×N2×{(1/N12)+(1/N11)}/2

Vb=E0×N2×{(1/N12)−(1/N11)}/2.

Hence, by appropriately selecting a difference between the numbers of turns N11 and N12 of the primary windings, a desired direct-current offset voltage can be set.

Based on the above-described configuration, the effect of an improvement in luminance distribution is examined by using the power supplies E1 and E2 composed of actual inverter circuits and lighting the lamp 1 actually. The configuration of the lamp 1 is the same as that used in the first embodiment.

FIG. 6A shows a waveform of a voltage to be outputted to the internal electrode 2b from the power supply E2 in the actual circuit. Here, a direct-current offset voltage is set about 70 V (about 3.5% of the amplitude of a substantial rectangular wave alternating voltage). Voltage overshoot at the time of voltage rising/falling caused by back electromotive forces at the step-up transformers T1 and T2 is observed, and the waveform of a rectangular wave is slightly distorted due to leakage inductance of the windings and parasitic capacitance held by the step-up transformers T1 and T2. However, a voltage waveform of combination of a roughly rectangular wave alternating voltage and a direct-current offset voltage is favorably outputted. Note that a voltage waveform to be outputted to the internal electrode 2a from the power supply E1 is a substantially reversed one of the waveform shown in FIG. 6 and thus the explanation thereof is omitted.

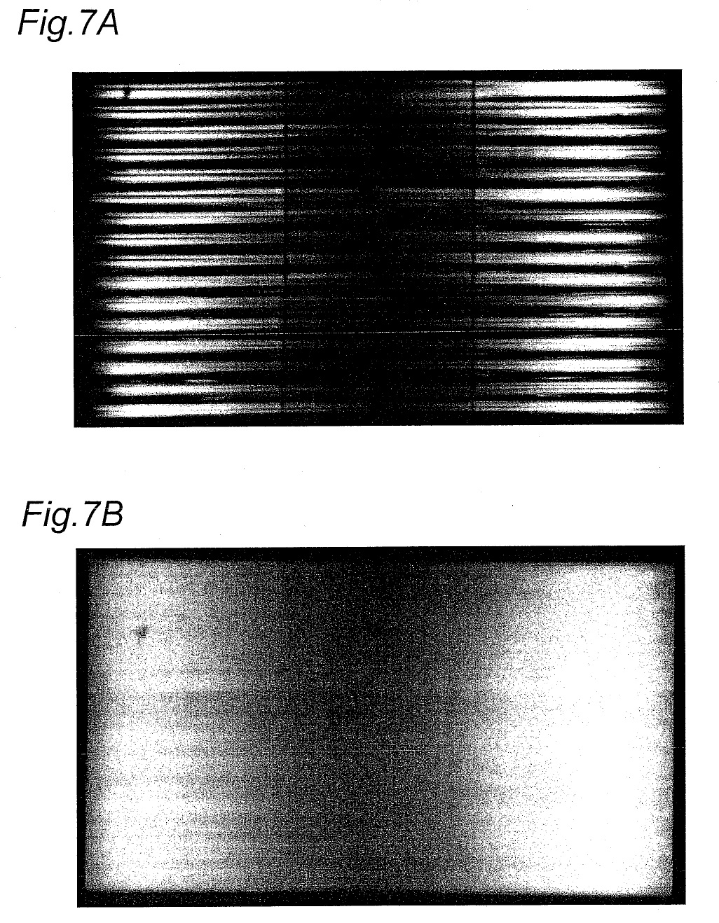

FIGS. 7A and 7B show pictures taken of light emission states of the lamps 1 for the case in which the lamps 1 are lighted in a conventional method of keeping the internal electrodes 2a and 2b at equal potential. FIG. 7A shows a picture taken with a diffuser removed so that dark portions formed in the vicinity of the center in the longitudinal direction of the lamps 1 can be easily seen, and FIG. 7B is a picture taken with a diffuser disposed. It can be seen as shown in FIG. 7A that since the difference in luminance between the dark portions and the periphery thereof is remarkable, the dark portions are more easily visually recognized than they actually are. As shown in FIG. 7B, even when a diffuser is disposed, distinct dark portions can be recognized at a central portion of the diffuser along dark portions on the lamps arranged substantially vertically.

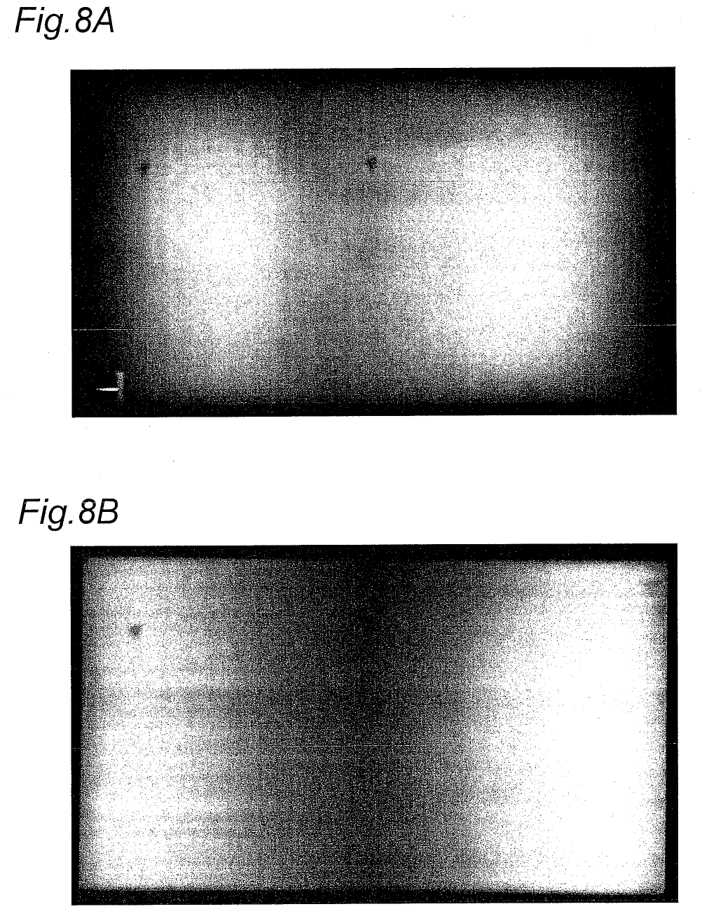

FIG. 8A is a picture showing a light emission state for the case in which the lamps 1 are actually lighted with the inverter power supplies E1 and E2 of the present embodiment. FIG. 8A is a picture taken with a diffuser disposed. Note that as a comparative example the same picture as that of FIG. 7B is shown in FIG. 8B. Note also that although it looks as if there are dark portions in somewhat upper regions of the left and center of the pictures of FIGS. 7B, 8A and 8B, they are shadows of stains attached to the camera. Comparing the two pictures of FIGS. 8A and B, an improvement in the visibility of the dark portions is admitted obviously.

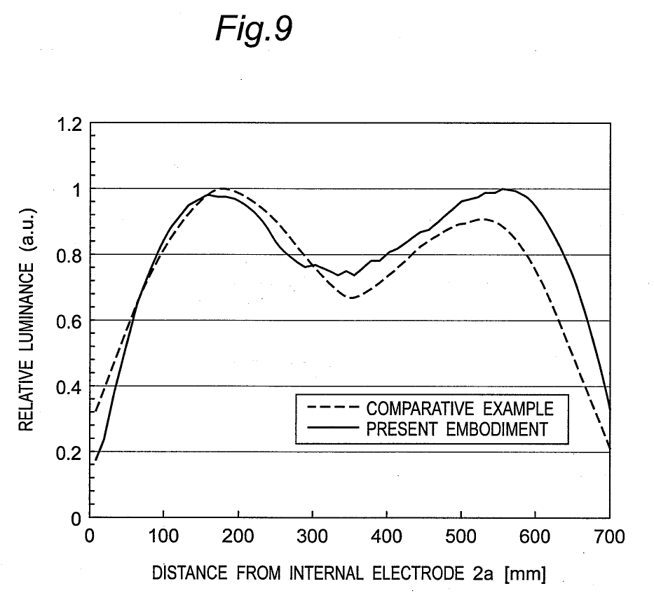

FIG. 9 shows a luminance distribution of the lamps 1 when the lamp 1 is actually lighted with the inverter power supplies E1 and E2 of the present embodiment, and, as a comparative example, a luminance distribution of the lamp 1 when the lamps 1 is lighted with the internal electrodes 2a and 2b being kept at equal potential. Also, in the case of the present embodiment, the luminance uniformity ratio (the value obtained by dividing minimum luminance by maximum luminance) is improved by about 6%. Note that since the differential value of the luminance distribution near dark portions becomes small, the dark portions are hardly recognized, providing the effect of a higher improvement than the degree of a numerical improvement, as described above.

Note that when the power supplies E1 and E2 are also configured by actual inverter circuits, it is preferred that the direct-current offset voltage Vb with respect to the amplitude Va of the substantial rectangular wave alternating voltage (except for a voltage overshoot portion) be selected as shown in the following equation. This is the same as that in the first embodiment.

0.025 Va≦Vb≦0.10 Va

Note also that although in the present embodiment the numbers of turns of the step-up transformers T1 and T2 are configured such that the primary windings L111 and L212 are equal to each other and the primary windings L112 and L211 are equal to each other, they may have a difference. However, in such a case a difference may occur in luminance between the portion on the internal electrode 2a side and the portion on the internal electrode 2b side, and thus attention should be paid.

Next, a preferred range of difference between the numbers of turns N11 and N12 of the primary windings will be described. A preferred range of difference between the numbers of turns N11 and N12 of the primary windings is preferably between one turn or two turns. A cold cathode fluorescent lamp is generally used as a backlight for a liquid crystal display. An input to a drive circuit of a backlight is mainly DC 12 V to 24V. Thus, though depending on the design of the lamp 1, the step-up ratio of the step-up transformers T1 and T2 needs to be 50 to 100. For example, when the number of turns N2 of the secondary windings L12 and L22 is 1000 turns, the number of turns of the primary winding is 20 turns for a step-up ratio of 50, or 10 turns for a step-up ratio of 100, which are very small numbers of turns. As described previously, when the direct-current offset voltage Vb is increased too high in order to widen the moving range of the dark portion, a reduction in efficiency may be caused or the dark portion cannot follow, causing flicker. Accordingly, it is preferable that the difference between the numbers of turns of the primary windings (=N11−N12) is restricted to one turn to two turns. In this case, for example, with the number of turns N2 of the secondary winding being 1000 turns and the step-up ratio being in a range of 50 to 100:

(1) when the step-up ratio is 50,

if the primary windings are set to 20 and 19 turns, then the offset voltage is 2.56% of the AC voltage, or

if the primary windings are set to 20 and 18 turns, then the offset voltage is 5.26% of the AC voltage;

(2) when the step-up ratio is 100,

if the primary sides are set to 10 and 9 turns, then the offset voltage is 5.26% of the AC voltage, or

if the primary sides are set to 10 and 8 turns, then the offset voltage is 11.11% of the AC voltage.

Accordingly, it is practical to set the difference between the numbers of turns of the primary windings (=N11−N12) to one turn to two turns. Note that depending on the pin disposition of bobbins (frames of windings) of the step-up transformers T1 and T2, the difference may have a fraction such as 1.5 turns.

### Third Embodiment

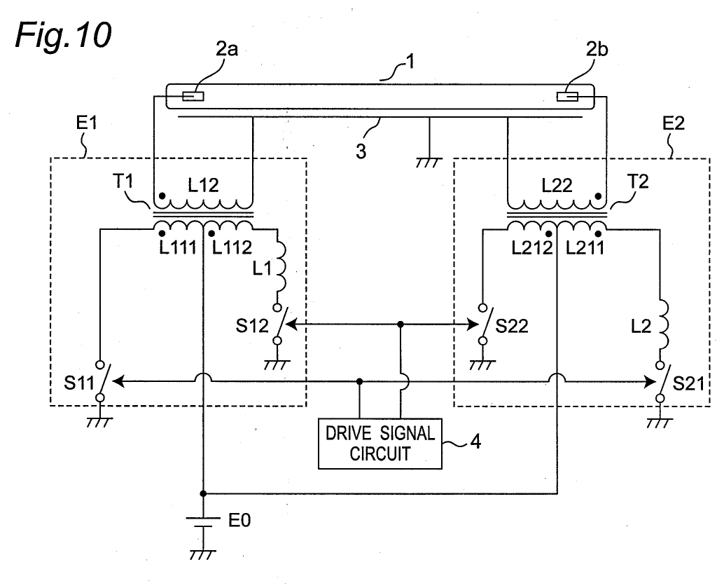

FIG. 10 is a diagram showing a configuration of a lighting apparatus for a dielectric barrier discharge lamp according to a third embodiment of the present invention. In the present embodiment, series inductors L1 and L2 are respectively connected series to those primary windings with a smaller number of turns out of the primary windings of the step-up transformers T1 and T2 of the second embodiment. The operations of power supplies E1 and E2 are the same as those for the case of the lighting apparatus of the second embodiment and thus a detailed description thereof is omitted.

As in the case of the above-described second embodiment, when a difference is made between the numbers of turns on the primary windings of the step-up transformers T1 and T2, a problem such as that shown below may occur.

Electrons emitted from the internal electrodes 2a and 2b when negative high voltages are applied to the internal electrodes 2a and 2b are trapped on an inner wall of the lamp 1. This is called “wall charges”. The trapped electrons are sequentially emitted from regions near the internal electrodes 2a and 2b at the moment when the voltages applied to the internal electrodes 2a and 2b are reversed to positive, and return to the internal electrodes 2a and 2b. At this time, the electrons trapped near the internal electrodes 2a and 2b are always discharged toward their nearest internal electrode whatever positive voltage is applied to the internal electrodes 2a and 2b. This is caused for the following reason. The length of the lamp 1 is sufficiently long as comparing with a potential difference between the internal electrode 2a and the internal electrode 2b and furthermore the electric field strength decreases as going away from the internal electrodes 2a and 2b. Therefore, for example, a region near the internal electrode 2a is hardly affected since it is located furthest from the internal electrode 2b. Also, in a region near the internal electrode 2b, similarly, regardless of the potential of the internal electrode 2a, electrons near the internal electrode 2b are emitted toward the internal electrode 2b.

Due to such a phenomenon, lamp currents that flow when voltages applied to the internal electrodes 2a and 2b are reversed, i.e., peak values I of currents flowing through secondary windings L12 and L22 of the step-up transformers T1 and T2 become substantially same between when the voltages are reversed from positive to negative and when the voltages are reversed from negative to positive, despite the fact that the voltages applied to the internal electrodes 2a and 2b are different. Note that near a central portion in a longitudinal direction of the lamp 1, since a distance from the internal electrode 2a and a distance from the internal electrode 2b are almost even, an electric field direction is determined according to a balance between voltages applied thereto. As in the present embodiment, when a positive voltage offset is provided to the internal electrode 2a and a negative voltage offset is provided to the internal electrode 2b, wall charges in the vicinity of the center of a tube of the lamp 1 are supplied from the internal electrode 2b side when a negative voltage is provided and are emitted from the internal electrode 2a side when a negative voltage is provided.

As such, the peak values of currents flowing through the secondary windings L12 and L22 of the step-up transformers T1 and T2 are almost same between when the current is positive and when the current is negative. However, the primary windings L111, L112, L211, and L212 have different numbers of turns. Taking the step-up transformer T1 as an example, a maximum magnetomotive force generated during a period in which a current flows through the primary winding L111 is the product of the number of turns N11 and the peak current I. Next, a maximum magnetomotive force generated during a period in which a current flows through the primary winding L112 is the product of the number of turns N12 and the peak current I. That is, compared to the period in which a current flows through the primary winding L112 with a smaller number of turns, in the period in which a current flows through the primary winding L111 with a greater number of turns, a magnetomotive force generated in the step-up transformer T1 is higher and thus saturation of the step-up transformer T1 is relatively likely to occur.

To solve the above-described problem, in the present embodiment, an impedance element is inserted in series to a primary winding with a smaller number of turns. In the configuration of FIG. 10, the series inductors L1 and L2 each correspond to the inserted impedance element.

Insertion of the series inductors L1 and L2 respectively to the primary windings L112 and L211 with a smaller number of turns, i.e., with higher step-up ratio, allows the peak values of currents flowing through the primary windings L112 and L211 to be suppressed. As a result, a current peak value flowing through the lamp 1 is limited. By this, the peak values of currents flowing through the primary windings L111 and L212 with a greater number of turns also become substantially equal to the aforementioned limited peak value. Accordingly, an effect is provided that saturation of the step-up transformers T1 and T2 is less likely to occur.

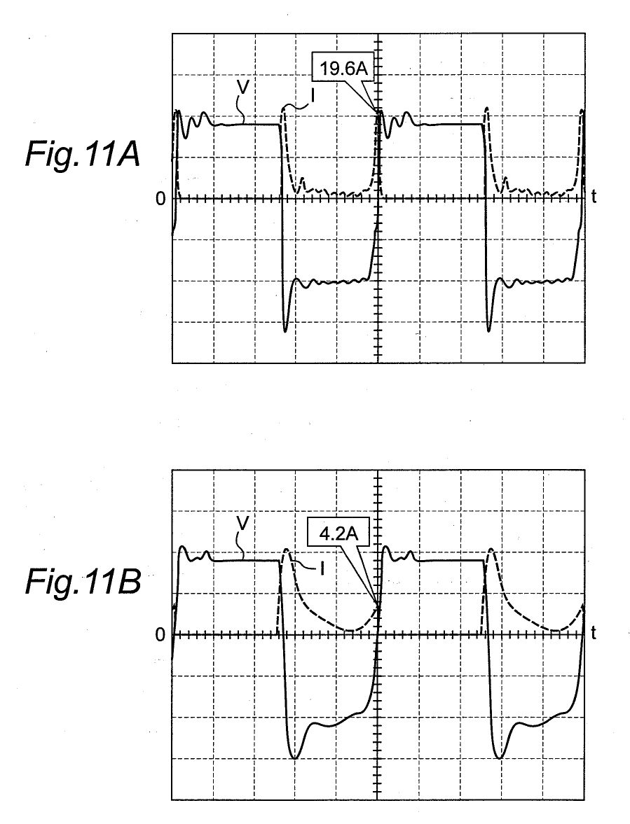

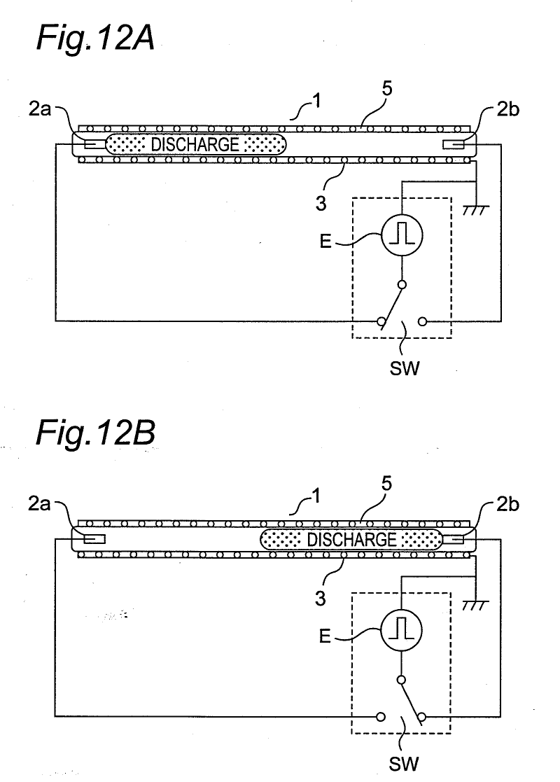

The voltage and current waveforms of the power supply E1 before and after the insertion of the inductor L1 are shown in FIGS. 11A and 11B. FIG. 11A shows waveforms before the insertion of the inductor L1 and FIG. 11B shows waveforms after the insertion of the inductor L1. In FIGS. 11A and 11B, a waveform V is a waveform of a voltage applied to the internal electrode 2a and a waveform I is a waveform of a current flowing through a switching element S11. Note that in FIGS. 11A and 11B the vertical axis scale for the current waveform is different. In FIGS. 11A and 11B, the inductance of the primary winding L112 is about 520 μH and the inductor L1 is set to 4 μH which is a sufficiently small value for the inductance of the primary winding L112.

Referring to FIG. 11B, it can be seen that due to the effect of the inserted inductor L1, a current change becomes gradual and the peak value of a current pulse is reduced and the time constant is increased. Also, for a saturation current, by the effect of the inductor, a pulse shaped saturation current is inhibited from flowing and the peak value of the saturation current is significantly reduced from 19.6 A to 4.2 A. In addition, since the value of a current that flows at the moment of a switching operation is significantly reduced, the heat generation of the switching element S11 is reduced. Although in the case of FIG. 11A the temperature of the switching element exceeds 100 degrees, in the case of FIG. 11B the temperature is around 80 degrees so that a safety operation is achieved.

Note that although as an impedance element a resistance element can also be considered, the current of the primary windings L111 and L112 results in a value obtained by multiplying a current flowing through the lamp 1 by a step-up ratio (generally, 50 to 100), which is a very high current and thus it is preferred to use an inductor of which power loss is small. Also, it is preferred that the inductance of the inductor L1 be from 1 μH to 5 pH. At below 1 μH the effect of suppression of a saturation current may hardly be obtained, and at above 5 μH an abrupt change in current is inhibited. As a result, a driving waveform is significantly distorted and the light emission efficiency of the lamp 1 significantly decreases.

It is to be understood that the concept of the present invention is not limited to the configurations disclosed in the above-described first to third embodiments, and various changes may be made without departing from the spirit and scope of the present invention.

It is preferable to drive two power supplies E1 and E2 by a single drive signal circuit 4, as shown in the second and third embodiments. Even when each power supply has a drive signal circuit 4, the effect of improving a luminance distribution of the lamp 1 can be obtained. However, it needs to design such that the frequencies and phases of drive signals match each other. The reason for that is as follows. For example, at the moment at which the voltage of the internal electrode 2a turns positive and the voltage of the internal electrode 2b turns negative, the discharge occurs not between the internal electrodes 2a and 2b and the external electrode 3 but between the internal electrodes 2a and 2b. Thus, not only the light emission efficiency of the lamp 1 decreases, but also the circuit operation is likely to become unstable due to a sudden change in the impedance of the lamp 1. To place the respective drive signal circuits 4 in the power supplies E1 and E2 individually, it may be considered, for example, to provide the drive signal circuits 4 which is composed of a microcomputer or the like, that is operable to make frequencies equal in precisely and start the drive signal circuits 4 upon receipt of a common signal for starting oscillation. At any rate, taking into account the stability of circuit operation and cost, it is practical to provide a signal drive signal circuit 4.

Although in the first to third embodiments a xenon gas is used as a fill gas of the lamp 1, xenon, krypton, argon, neon, helium or a mixture gas appropriately selected from the group consisting of such gas may be used. The effects of the present invention are not limited by the type of fill gas. Also, the effects of the present invention are not limited by the pressure of the fill gas.

The effects of the present invention are not affected by the shape of the external electrode 3 because the mechanism of improvement in light emission luminance distribution by movement of a dark portion is not dependent on the electrode shape.

Note that the voltage range for the power supplies E is most commonly 12 V or 24 V for the case of a backlight for liquid crystal display. However, the effects of the present invention are not affected by the power supply voltage.

Also, the effects of the present invention are not affected by the driving frequency. However, when the driving frequency is too high, the voltage is reversed before excimer light emission by a rare gas sufficiently occurs, and thus excimer molecules are destroyed by reverse current, deteriorating the light emission efficiency of the lamp. Accordingly, a preferred driving frequency range is from 10 kHz to 50 kHz.

Although for the switching elements S11, S12, S21, and S22, bipolar transistors or MOSFETs are commonly used, it is apparent that the effects of the present invention are not affected by the type of switching element.

### INDUSTRIAL APPLICABILITY

A lighting apparatus for a dielectric barrier discharge lamp of the present invention is capable of increasing the uniformity ratio without impairing light emission efficiency. Thus it is useful as a backlight for liquid crystal display, a light source for a document scanning apparatus, and so on.

1-13. (canceled)

14. An apparatus for lighting a dielectric barrier discharge lamp including a transparent container filled with a discharge medium containing a rare gas, a pair of internal electrodes at both ends of the transparent container, and an external electrode placed along a longitudinal direction of the translucent container, the lighting apparatus comprising:
a first drive circuit for generating a first substantial rectangular wave voltage including a predetermined substantial rectangular wave voltage on which a positive direct-current voltage is superimposed; and
a second drive circuit for generating a second substantial rectangular wave voltage including a predetermined substantial rectangular wave voltage on which a negative direct-current voltage is superimposed, wherein
the first drive circuit is connected to one of the pair of internal electrodes and the external electrode so as to apply the first substantial rectangular wave voltage thereto,
the second drive circuit is connected to the other of the pair of internal electrodes and the external electrode so as to apply the second substantial rectangular wave voltage thereto, and
the amplitude of the substantial rectangular wave voltage is greater than the amplitude of the positive and negative direct-current voltages superposed on the substantial rectangular wave voltage.

15. The lighting apparatus according to claim 14, wherein the first substantial rectangular wave voltage and the second substantial rectangular wave voltage have substantially the same phase.

16. An apparatus for lighting a dielectric barrier discharge lamp including a transparent container filled with a discharge medium containing a rare gas, a pair of internal electrodes at both ends of the transparent container, and an external electrode placed along a longitudinal direction of the translucent container, the lighting apparatus comprising:
a first drive circuit for generating a first substantial rectangular wave voltage including a predetermined substantial rectangular wave voltage on which a positive direct-current voltage is superimposed; and
a second drive circuit for generating a second substantial rectangular wave voltage including a predetermined substantial rectangular wave voltage on which a negative direct-current voltage is superimposed,
wherein
the first drive circuit is connected to one of the pair of internal electrodes and the external electrode so as to apply the first substantial rectangular wave voltage thereto,
the second drive circuit is connected to the other of the pair of internal electrodes and the external electrode so as to apply the second substantial rectangular wave voltage thereto, and
the first substantial rectangular wave voltage and the second substantial rectangular wave voltage have substantially the same phase, and
the first drive circuit and the second drive circuit are inverter circuits which are driven by a single drive signal circuit.

17. The lighting apparatus according to claim 16, wherein
the first drive circuit has a first step-up transformer,
the first step-up transformer has a first primary winding, a second primary winding, and a first secondary winding,
the second drive circuit has a second step-up transformer,
the second step-up transformer has a third primary winding, a fourth primary winding, and a second secondary winding, and
a number of turns of the first primary winding is substantially equal to a number of turns of the fourth primary winding, and a number of turns of the second primary winding is substantially equal to a number of turns of the third primary winding.

18. The lighting apparatus according to claim 17, wherein a difference in number of turns between the first primary winding and the second primary winding is between one turn and two turns.

19. The lighting apparatus according to claim 17, wherein an impedance element is connected in series to at least a primary winding with a smallest number of turns among the first to fourth primary windings.

20. The lighting apparatus according to claim 19, wherein the impedance element is an inductor having an inductance of between 1 μH and 5 μH.

21. An apparatus for lighting a dielectric barrier discharge lamp including a transparent container filled with a discharge medium containing a rare gas, a pair of internal electrodes at both ends of the transparent container, and an external electrode placed along a longitudinal direction of the translucent container, the lighting apparatus comprising:
a first drive circuit for generating a first substantial rectangular wave voltage including a predetermined substantial rectangular wave voltage on which a positive direct-current voltage is superimposed; and
a second drive circuit for generating a second substantial rectangular wave voltage including a predetermined substantial rectangular wave voltage on which a negative direct-current voltage is superimposed,
wherein
the first drive circuit is connected to one of the pair of internal electrodes and the external electrode so as to apply the first substantial rectangular wave voltage thereto,
the second drive circuit is connected to the other of the pair of internal electrodes and the external electrode so as to apply the second substantial rectangular wave voltage thereto,
the positive direct-current voltage and the negative direct-current voltage have a substantially equal absolute value, and
a relationship between an amplitude Va of the predetermined substantial rectangular wave voltage and an absolute value Vb of the positive and negative direct-current voltages satisfies the following equation,
0.025 Va≦Vb≦0.10 Va.

22. A method of lighting a dielectric barrier discharge lamp including a transparent container filled with a discharge medium containing a rare gas, a pair of internal electrodes at both ends of the transparent container, and an external electrode placed along a longitudinal direction of the translucent container, the method comprising:
applying a first substantial rectangular wave voltage to one of the internal electrodes, the first substantial rectangular wave voltage including a predetermined substantial rectangular wave voltage on which a positive direct-current voltage is superimposed; and
applying a second substantial rectangular wave voltage to the other of the internal electrodes, the second substantial rectangular wave voltage including a predetermined substantial rectangular wave voltage on which a negative direct-current voltage is superimposed,
wherein the amplitude of the substantial rectangular wave voltage is greater than the amplitude of the positive and negative direct-current voltages superposed on the substantial rectangular wave voltage.

23. The lighting method according to claim 22, wherein the first substantial rectangular wave voltage and the second substantial rectangular wave voltage have substantially the same phase.

24. The lighting method according to claim 22, wherein a relationship between an amplitude Va of the predetermined substantial rectangular wave voltage and an absolute value Vb of the positive and negative direct-current voltages satisfies a following equation,
0.025 Va≦Vb≦0.10 Va.
